(19) United States
(12) Patent Application Publication
(10) Pub. No.: US 2012/0027509 A1
(43) Pub. Date: Feb. 2, 2012

(54) RETENTION SYSTEM

(75) Inventors: Tomas R. Leutwiler, Enfield, CT (US); Francis P. Marocchini, Somers, CT (US)

(73) Assignee: HAMILTON SUNDSTRAND CORPORATION, Windsor Locks, CT (US)

(21) Appl. No.: 12/847,455

(22) Filed: Jul. 30, 2010

(51) Int. Cl. F16B 7/00; B23P 19/00

(52) U.S. Cl. 403/319; 29/426.2

(57) ABSTRACT

A system to retain a sleeve within a housing includes a sleeve, a spring loaded retaining pin which can be moved to be fully within the sleeve, a locking pin to hold the retaining pin within the sleeve when the sleeve is being set into or withdrawn from the housing, and an annular recess in the housing to receive the retaining pin when the sleeve is set in the housing, the locking pin is removed and the retaining pin is pushed outward by the spring. The sleeve is retained within the housing when the spring pushes the retaining pin outward so that the retaining pin engages the annular recess in the housing.

### BACKGROUND

The present invention relates to a retention system and more particularly to a retention system suitable for use in hydraulic flow systems.

Hydraulic units are used in a variety of applications, including refrigeration systems. Most units consist of a housing with one or more bores in which valves or other components are installed to control the performance of the assembly and control pressure and flow within assembly passageways. The valves need a retention device to hold them in place. The most common types of retention for these devices are threaded sleeves or spools which need to be torqued into place. Due to thermal and vibrational forces acting on flow systems, especially those in the aerospace industry, threaded closures run the risk of becoming loose and backing out. Therefore, secondary retention methods are required to accompany the threaded closures. Some common secondary retention devices used are lock-wire (wire is mechanically attached to the threaded member and locked to another place), locking pellets and locking inserts. While these conventional methods work, they require adequate spatial envelope to fit within a system. In addition, they also place additional constraints on how the system may be set up, as well as adding weight to the system.

### SUMMARY

A system to retain a sleeve within a housing includes a sleeve, a spring loaded retaining pin which can be moved to be fully within the sleeve, a locking pin to hold the retaining pin within the sleeve when the sleeve is being set into or withdrawn from the housing, and an annular recess in the housing to receive the retaining pin when the sleeve is set in the housing, the locking pin is removed and the retaining pin is pushed outward by the spring. The sleeve is retained within the housing when the spring pushes the retaining pin outward so that the retaining pin engages the annular recess in the housing.

A method of retaining a sleeve within a housing includes inserting a first spring loaded retaining pin into a first blind hole within a sleeve; moving the first retaining pin so that the spring is compressed and the first retaining pin is totally inside the sleeve by engaging a part of the first retaining pin with a tool going though a first slot in communication with at least part of the first blind hole; and inserting a first locking pin into a first locking hole which intersects with the first blind hole so that the first locking pin holds the first retaining pin within the sleeve, compressing the springs. It further includes inserting the sleeve into the housing and removing the locking pin to allow the first retaining pin to engage an annular recess in the housing.

### BRIEF DESCRIPTION OF THE DRAWINGS

FIG. 1A is an exploded view of the retention device of the current invention.

FIG. 1B is a perspective view of the retention device of the current invention being inserted into a housing.

FIG. 2A shows an end view of an embodiment of a retention device according to the current invention set in a housing.

FIG. 2B shows a cross sectional view of the retention device of FIG. 2A along line 2B-2B.

FIG. 2C shows a cross section view of the retention device of FIG. 2B along the line 2C-2C.

FIG. 3A shows a perspective view of an embodiment of the retention device of the current invention in a housing, and with a tool compressing a retaining pin within the sleeve to enable removal of the sleeve from the housing.

FIG. 3B shows a cross sectional view of an embodiment of the retention device of the current invention with the pins compressed into the sleeve and held there by locking pins.

FIG. 4 shows a cross-sectional view of a section of a flow system which uses an embodiment of the retaining device of the current invention.

### DETAILED DESCRIPTION

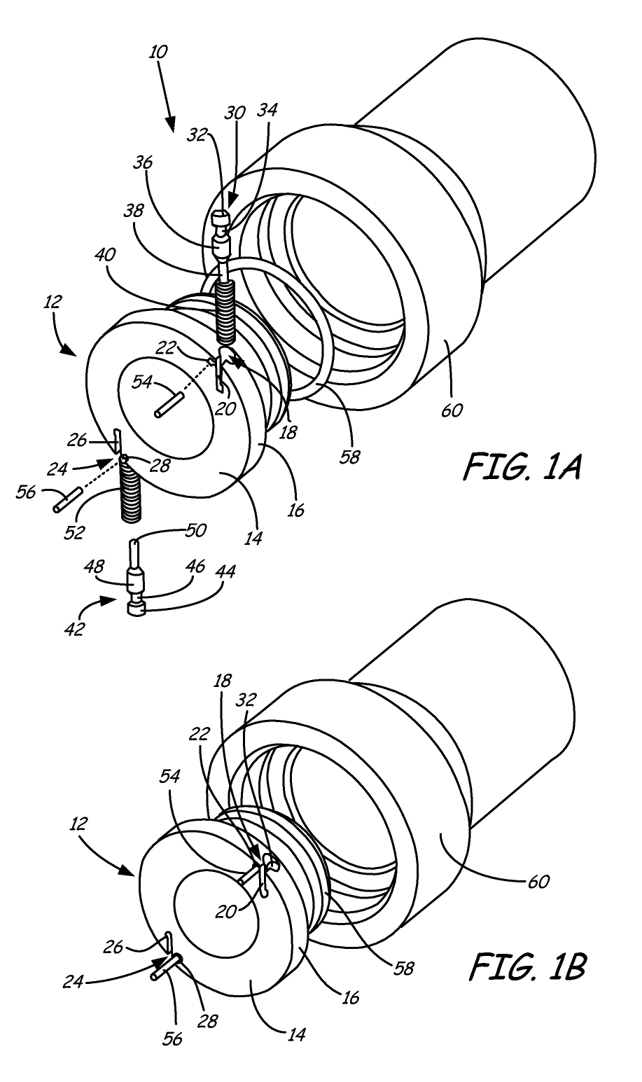

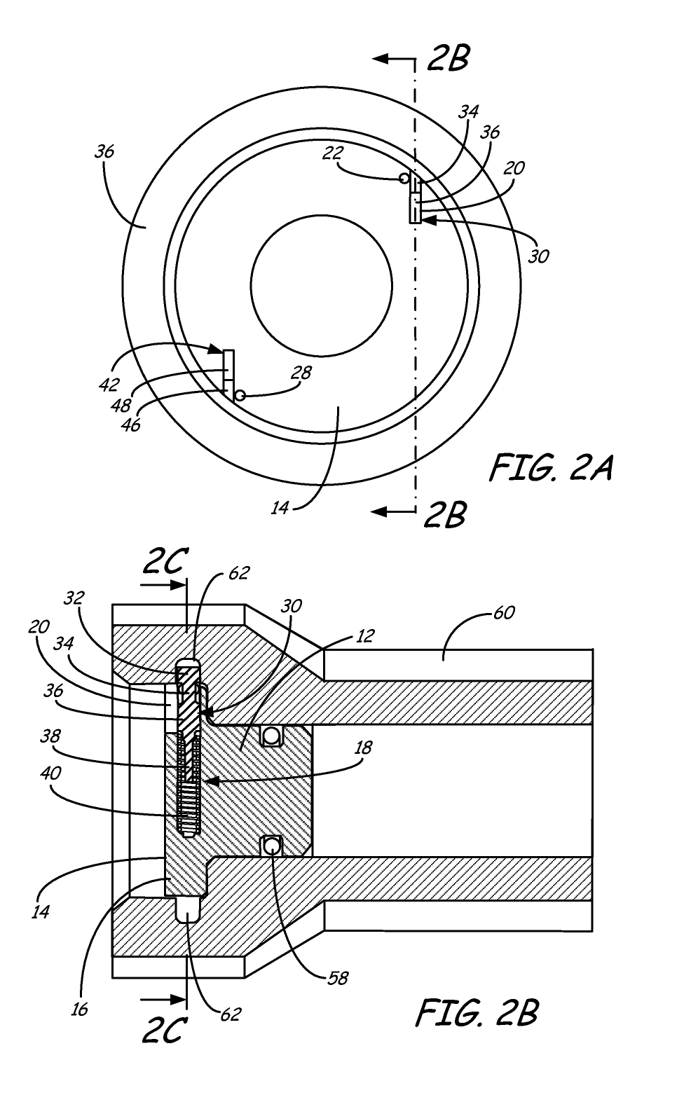

FIG. 1A is an exploded view of the retention system of the current invention. FIG. 1B is a perspective view of the retention system of the current invention being inserted into a housing. FIGS. 1A-1B include retention system 10 with valve sleeve 12 (which includes front face 14; flange 16; first blind hole 18 with slot 20 and locking hole 22, and second blind hole 24 with slot 26 and locking hole 28), first retaining pin 30 (with head 32, neck 34, shoulder 36 and stem 38) with spring 40, and second retaining pin 42 (with head 44, neck 46, shoulder 48 and stem 50) with spring 52, first locking pin 54, second locking pin 56, O-ring 58 and housing 60 with an annular recess 62 (see FIGS. 2B-2C).

Valve sleeve 12 includes first blind hole 18 and second blind hole 24 in flange 16, extending into flange 16 and parallel with front face 14. Slot 20 is in communication with at least part of first blind hole 18, and first locking hole 22 intersects with first blind hole 18. Slot 26 is in communication with at least part of second blind hole 24, and second locking hole 28 intersects with second blind hole 24. First blind hole 18 holds first retaining pin 30 and spring 40. Second blind hole 24 holds second retaining pin 42 and spring 52. Spring 40 connects to stem 38 of first retaining pin 30 and pushes retaining pin 30 outward from blind hole 18. Spring 52 connects to stem 50 of second retaining pin 42 and pushes second retaining pin 42 outward from second blind hole 24. Blind holes 18, 24 are of sufficient length so that each respective spring can compress and heads 32, 44 of retaining pins 30, 42 can fit entirely within flange 16 of valve sleeve 12. Retaining pins 30, 42 can be made of a metallic material such as steel or aluminum or a plastic, depending on requirements of the system.

FIG. 1B shows a perspective view of the retention device of the current invention being inserted into a housing. Retaining pins 30, 42 are compressing springs 40, 52 so that retaining pins 30, 42 are sitting completely inside flange 16 of valve sleeve 12. First locking pin 54 is inserted into first locking hole 22 to hold head 32 of first retaining pin 30 within sleeve 12, and second locking pin 56 is inserted into second locking hole 28 to hold head 44 of second retaining pin 42 within sleeve 12. This enables sleeve 12 to easily slide into housing 60. Locking pins 54, 56 each have a portion that is not inside of locking holes 22, 28 when inserted. This portion which “sticks out” provides an portion of each locking pin to easily grip and pull on when removal of locking pins 54, 56 is desired (when springs 40, 52 no longer need to be compressed due to sleeve 12 being set within housing 60).

FIG. 2A shows an end view of an embodiment of a retention system according to the current invention set in a housing. FIG. 2B shows a cross sectional view of the retention system of FIG. 2A along line 2B-2B. FIG. 2C shows a cross section view of the retention system of FIG. 2B along the line 2C-2C. FIGS. 2A-2C include valve sleeve 12 (which includes front face 14; flange 16; first blind hole 18 with first slot 20 and first locking hole 22, and second blind hole 24 with second slot 26 and second locking hole 28), first retaining pin 30 (with head 32, neck 34, shoulder 36 and stem 38) with spring 40, and second retaining pin 42 (with head 44, neck 46, shoulder 48 and stem 50) with spring 52, first locking pin 54, second locking pin 56, O-ring 58 and housing 60 with annular recess 62.

As mentioned in relation to FIGS. 1A-1B, valve sleeve 12 is retained within housing 60 through retention system 10. Retaining pin 30 and spring 40 sit in first blind hole 18. Spring 40 contacts stem 38 of retaining pin 30 to push retaining pin 30 outward towards housing 60. When spring 40 pushes retaining pin 30 outwards, head 32 of retaining pin 30 engages recess 62 in housing 60. Second retaining pin 42 sits in second blind hole 24 and is pushed outward by spring 52 (in contact with stem 50 of retaining pin 42) so that head 44 of retaining pin 42 engages recess 62 in housing 60.

Blind holes 18, 24 are strategically placed in sleeve 12 at positions so that retaining pins 30, 42 can sit totally within flange 16 of sleeve 12 for installation or removal of sleeve 12 from housing 60, and so that when sleeve 12 is set in housing 60, pins 30 and 42 can act together to retain sleeve 12 in place within housing 60. This retention is attained by retaining pins 30, 42 being pushed outwards by springs 40, 52 so that heads 32, 44 engage annular recess 62 in housing 60.

Through the use of spring loaded pins which can retract to fit entirely within blind holes in a sleeve, the retention system of the current invention can securely hold a valve sleeve in place within a housing without the need for secondary retention systems which may take up additional space, weight, block some flow within the system and/or add other constraints to the system. In past systems, threaded closures were often used to retain valve sleeves and spools within housings. Because many flow systems are subject to thermal and vibrational forces, especially those in the aerospace industry, the threaded closures ran the risk of becoming loose and backing out. Therefore, secondary retention methods were required. These included such things as lock-wire, where wire is mechanically attached to the sleeve and locked to another place. Other methods of secondary retention used are lock pellets or locking inserts which may impede flow. The current invention retains a sleeve within a housing without the need for a secondary retention system and the additional constraints added by the secondary retention system which the torqued retention systems require.

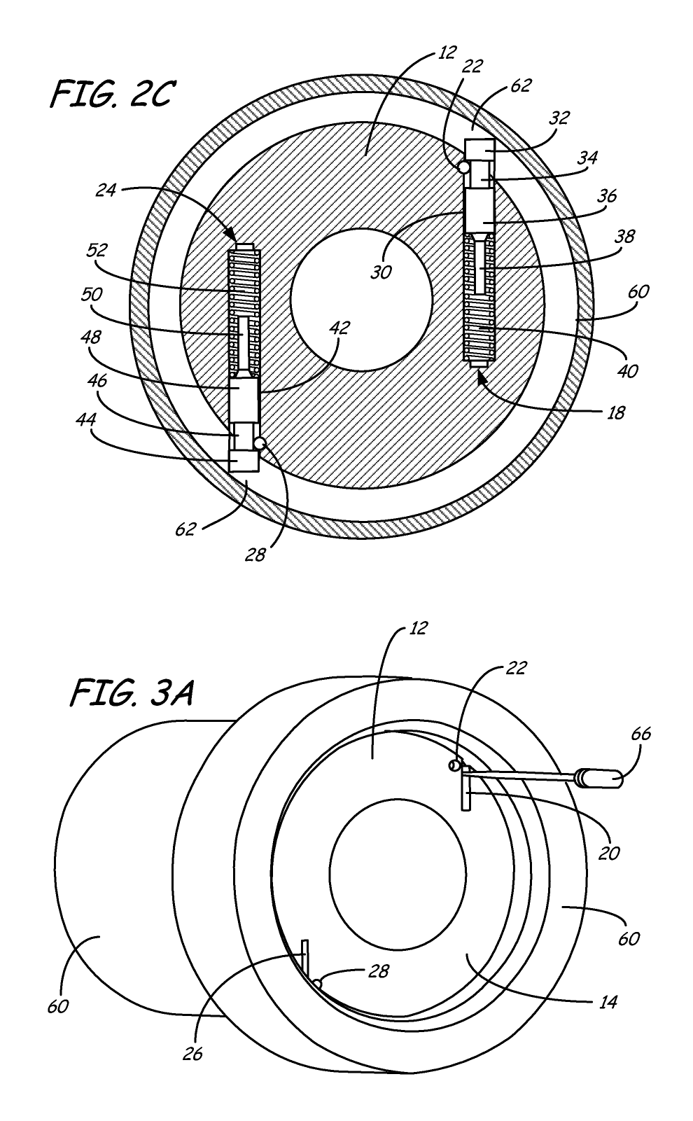

FIG. 3A shows a perspective view of an embodiment of the retention system of the current invention in a housing, and with a tool, such as an ice pick, compressing a retaining pin within the sleeve to enable removal of the sleeve from the housing. FIG. 3B shows a cross sectional view of an embodiment of the retention system of the current invention with the pins compressed into the sleeve and held there by locking pins. FIGS. 3A-3B include valve sleeve 12 with front face 14, flange 16, first blind hole 18 with first slot 20 and first locking hole 22, and second blind hole 24 with second slot 26 and second locking hole 28; first retaining pin 30 (with head 32, neck 34, shoulder 36 and stem 38) with spring 40; and second retaining pin 42 (with head 44, neck 46, shoulder 48 and stem 50) with spring 52; first locking pin 54; second locking pin 56; housing 60 with recess 62; and tool 66.

Tool 66 goes into slot 20, engages neck 34 of retaining pin 30, and moves pin 30 further into blind hole 18. This movement of pin 30 compresses spring 40 and moves head 32 of pin 30 within flange 16 of sleeve 12. Once head 32 of pin 30 is within flange 16 of sleeve 12, first locking pin 54 can be inserted into locking hole 28 (which intersects with blind hole 18). Tool 66 can then be removed from slot 20, and locking pin 54 (in locking hole 28) blocks head 32 of spring 30 from moving outwards towards housing, and therefore keeps spring 40 compressed and pin 30 entirely within sleeve 12. The same procedure can be used to compress spring 52 and retain pin 42 within blind hole 24 using locking pin 42.

As seen in FIGS. 3A-3B, sleeve 12 with retention system can easily be set in or removed from within housing 60. This can be done by using tool 66, which may be any suitable tool (e.g., an awl, an ice pick, etc.), to engage the neck of the retaining pin, and move the pin further into the blind hole in the sleeve so that the head of the pin is within the sleeve, compressing the spring which is in contact with the pin stem. The pin can be held in that position by inserting a locking pin into the locking hole. Because the locking hole intersects the blind hole, the locking pin contacts the head of the pin keeping the pin within the sleeve and the spring compressed to easily set in or remove the sleeve from a housing. This design enables the sleeve and retention device to be inserted, removed and reused, as nothing is damaged through use of a tool to engage the neck of the pin, move it inwards and use of an easily removable locking pin to prevent the retaining pin from moving outward during setting in or removal of the sleeve from the housing.

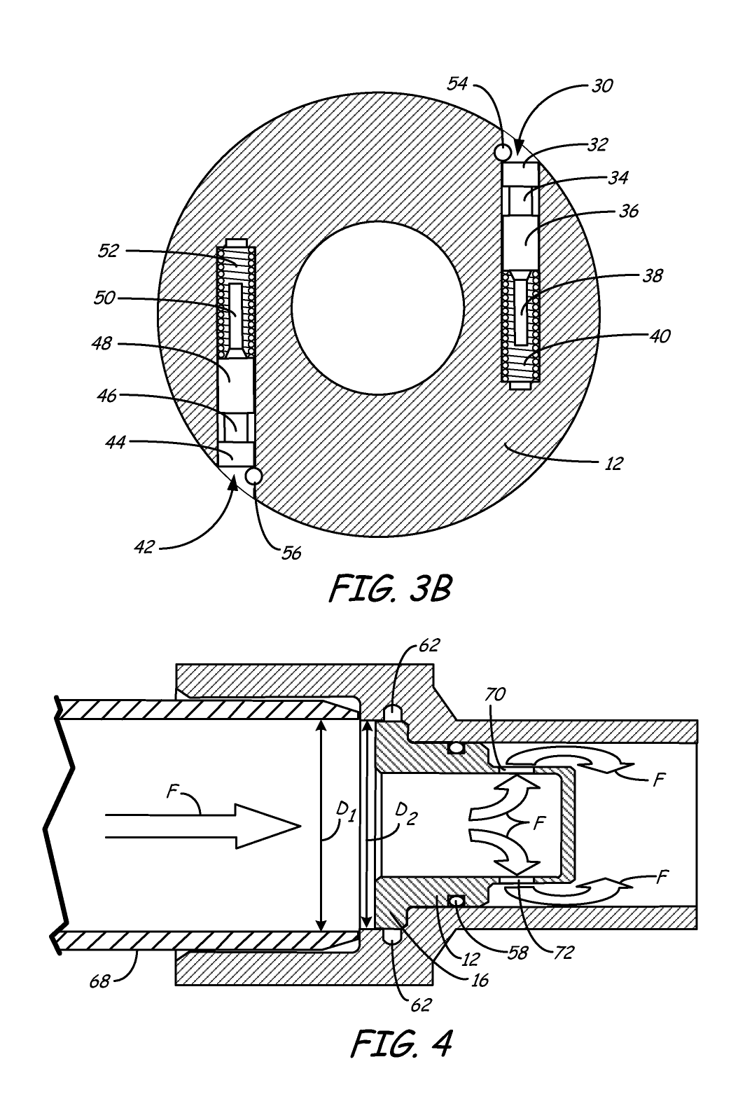

FIG. 4 shows a cross-sectional view of a section of a flow system which uses an embodiment of the retaining system of the current invention, and includes pipe fitting 68 with inner diameter D₁; valve sleeve 12 with flange 16, flow channels 70, 72 and outer diameter D₂; O-ring 58; housing 60 with annular recess 62 and arrows indicating fluid flow F.

Pipe fitting 68 is welded into housing 60 to bring pipe fitting 68 and sleeve 12 into fluid flow communication. Sleeve 12 is retained within housing 60 by heads 32, 44 of pins 30, 42 being pushed outward (by springs 40, 52 acting on pins 30, 42, see FIGS. 2B-2C) to engage recess 62.

As can be seen in FIG. 4, outer diameter D₂ of sleeve 12 is smaller than inner diameter D₁ of pipe fitting 68. By using spring loaded pins 30, 42 which fit into blind holes 18, 24 within housing 60, sleeve 12 is able to be retained in this system despite the outer diameter D₂ of sleeve 12 being smaller than inner diameter D₁ of pipe fitting 68. The current invention retains sleeve within a housing even in “stepped bore” situations as demonstrated in FIG. 4, while eliminating the need to use secondary retention system (as needed in past systems) which can impede some flow and add weight to the system.

In summary, the retention system described herein is a simple and small means to retain flow controlling assemblies within a housing through the use of blind holes with springs, retaining pins and an annular recess in the housing which also allows easy insertion and removal of the sleeve from the housing. The easy insertion and removal comes from the retaining pins and springs sitting in the blind holes, and the retaining pins being able to be moved completely into the blind hole by a tool engaging the retaining pin neck through a slot in communication with at least a part of the blind hole, and the retaining pin being able to be retained in that position with an easily removable locking pin inserted a locking hole, allowing the sleeve with retention system to be easily inserted, removed and reused. This design can reduce or eliminate the need for additional closures and retention means, and add more flexibility into design of the overall system. The smaller size also reduces the weight of the system, resulting in economic benefits.

While the invention has been discussed mostly in relation to including two spring loaded retaining pins, it can include only one spring loaded retaining pin or three or more spring-loaded retaining pins to hold the valve sleeve in place depending on the requirements of the system. The spring-loaded retaining pins can also have a different configuration than those shown in FIGS. 1A-4, as long as they are able to sit fully within the valve sleeve for installation and removal and be pushed outward into holes in the housing when the sleeve is set within the housing. Generally, if three spring-loaded retaining pins are used, they would be similar to what is shown in FIGS. 1A-3B, only the three spring-loaded retaining pins would be equally spaced throughout the sleeve, sitting about 120 degrees apart. If four pins were used, they would sit about 90 degrees apart and generally be equally spaced.

While the invention has been discussed mostly in relation to setting a valve sleeve within a housing, it could also be used to retain a closure, a static spool or other mechanisms in place within a housing, a bore or another structure in which they sit. It is intended mainly for unidirectional flow systems, but can withstand reduced loading in bi-directional flow systems. The system may be used as part of a hydraulic flow system in an aerospace application.

While the invention has been described with reference to an exemplary embodiment(s), it will be understood by those skilled in the art that various changes may be made and equivalents may be substituted for elements thereof without departing from the scope of the invention. In addition, many modifications may be made to adapt a situation or material to the teachings of the invention without departing from the essential scope thereof. Therefore, it is intended that the invention not be limited to the embodiment(s) disclosed, but that the invention will include all embodiments falling within the scope of the appended claims.

1. A system for retaining a sleeve within a housing, the system comprising:
a sleeve with a face and a flange to set inside the housing, the sleeve with a first blind hole in the flange parallel to the face, a first locking hole intersecting the first blind hole, and a first slot in the face in communication with at least a part of the first blind hole;
a first retaining pin set inside the first blind hole in the sleeve, and with a head to engage the housing, a neck which can be engaged through the slot to move the retaining pin further into the blind hole so that the pin head sits within the sleeve, a shoulder and a stem;
a first spring to engage the stem of the first retaining pin, wherein the first spring pushes the pin head outwards from the first blind hole;
a first locking pin to set in the first locking hole to hold the first retaining pin head within the sleeve when the sleeve is not set inside the housing; and
an annular recess in the housing to receive the head of the first retaining pin when the sleeve is set inside the housing and the first locking pin is removed, wherein the sleeve is retained within the housing when the first spring pushes the first pin outward so that the head of the first retaining pin engages the recess in the housing.

2. The system of claim 1, and further comprising:
a second blind hole in the flange parallel to the face, a second locking hole intersecting the second blind hole, and a second slot in the face in communication with at least a part of the second blind hole;
a second retaining pin set inside the second blind hole in the sleeve, and with a head to engage the housing, a neck which is engageable through the slot to move the second retaining pin further into the second blind hole so that the pin head sits within the sleeve, a shoulder and a stem;
a second spring to engage the stem of the second retaining pin, wherein the second spring pushes the pin head outwards from the second blind hole; and
a second locking pin to set in the second locking hole to hold the second retaining pin head within the sleeve when the sleeve is not set inside the housing; wherein the sleeve is retained within the housing when the second locking pin is removed and the second spring pushes the second pin outward so that the head of the first retaining pin engages the annular recess in the housing.

3. The system of claim 1, wherein the neck is engaged by a tool.

4. The system of claim 3, wherein the tool is an ice pick.

5. The system of claim 3, wherein the tool is an awl.

6. The system of claim 3, wherein after the sleeve has been set within the housing, the tool can be used to engage the neck to move the retaining pin into the sleeve until the head is within the sleeve, and the locking pin can be reinserted to keep the retaining pin within the sleeve, allowing for removal of the sleeve from the housing.

7. The system of claim 2, wherein when each locking pin is set in a locking hole, a portion of the pin is not in the hole.

8. The system of claim 2, wherein each retaining pin is made of a metallic material or plastic.

9. The system of claim 2, and further comprising:
an O-ring to form a tight seal between the sleeve and the housing.

10. The system of claim 2, wherein the sleeve is set within the housing to hold a valve in place.

11. The system of claim 10, wherein the valve is a unidirectional valve.

12. A system for retaining a static spool within a housing, the system comprising:
a first retaining pin to set within a first blind hole in a static spool, the first retaining pin with a head to engage the housing, a neck, a shoulder and a stem;
a first spring to contact the stem of the first retaining pin and to push the pin outward from the first blind hole in the static spool;
a tool to engage the neck of the retaining pin and move the retaining pin into the blind hole compressing the spring so that the head sits within the spool;
a first locking pin to set within a first locking hole in the static spool, wherein the first locking hole intersects with the first blind hole in the static spool so that when the tool has engaged the retaining pin and moved it so that the head sits within the static spool the first locking pin can hold it in that position; and
an annular recess in the housing to be engaged by the head of the first retaining pin when the static spool is set within the housing and the first locking pin is not in the first locking hole and the tool is not moving the first retaining pin into the first blind hole.

13. The system of claim 12, and further comprising:
a second retaining pin to set within a second blind hole in the static spool, the second retaining pin with a head to engage the housing, a neck which can be engaged by the tool to move the second retaining pin into the second blind hole so that the head sits within the static spool, a shoulder and a stem;
a second spring to contact the stem of the second retaining pin and to push the pin outward from the second blind hole in the static spool; and
a second locking pin to set within a second locking hole in the static spool, wherein the second locking hole intersects with the second blind hole in the static spool so that when the tool has engaged the retaining pin and moved it so that the head sits within the static spool the second locking pin can hold it in that position; wherein when the static spool is set within the housing and the second locking pin is not in the second locking hole, the head of the second retaining pin engages the annular recess to retain the static spool in the housing.

14. The system of claim 13, wherein the tool is an ice pick or an awl.

15. The system of claim 13, wherein each locking pin has a portion that does not enter into the locking hole when inserted.

16. The system of claim 13, wherein the static spool can be removed from the housing by engaging the neck of each retaining pin with the tool, moving each retaining pin so that the head is within the static spool, inserting the first and second locking pins to hold the first and second retaining pins in that position and removing the static spool from the housing.

17. A method of retaining a sleeve within a housing, the method comprising:
inserting a first spring loaded retaining pin into a first blind hole within a sleeve;
moving the first retaining pin so that the spring is compressed and the first retaining pin is totally inside the sleeve by engaging a part of the first retaining pin with a tool going though a first slot in communication with at least part of the first blind hole;
inserting a first locking pin into a first locking hole which intersects with the first blind hole so that the first locking pin holds the first retaining pin within the sleeve, compressing the springs;
inserting the sleeve into the housing; and
removing the first locking pin to allow the first retaining pin to engage an annular recess in the housing.

18. The method of claim 17, and further comprising:
inserting a second spring loaded retaining pin into a second blind hole within the sleeve;
moving the second retaining pin so that the spring is compressed and the second retaining pin is totally inside the sleeve by engaging a part of the second retaining pin with the tool going through a second slot in communication with at least part of the second blind hole;
inserting a second locking pin into a second locking hole which intersects with the second blind hole so that the second locking pin holds the second retaining pin within the sleeve, compressing the springs;
inserting the sleeve into the housing; and
removing the second locking pin to allow the second retaining pin to engage an annular recess in the housing.

19. The method of claim 18, wherein the sleeve can be removed from within the housing by moving the first retaining pin so that the spring is compressed and the first retaining pin is totally inside the sleeve by engaging a part of the first retaining pin with the tool going though the first slot in communication with at least part of the first blind hole and then inserting the first locking pin into the first locking hole which intersects with the first blind hole, and then moving the second retaining pin so that the spring is compressed and the second retaining pin is totally inside the sleeve by engaging a part of the second retaining pin with the tool going though the second slot in communication with at least part of the second blind hole and then inserting the second locking pin into the second locking hole which intersects with the second blind hole, so that the first locking pin and the second locking pin hold the first retaining pin and the second retaining pin within the sleeve, compressing the springs, and removing the sleeve from the housing.
